(19) United States
(12) Patent Application Publication
(10) Pub. No.: US 2018/0065525 A1
(43) Pub. Date: Mar. 8, 2018

(54) VEHICLE SEAT

(71) Applicant: TOYOTA JIDOSHA KABUSHIKI KAISHA, Toyota-shi (JP)

(72) Inventor: Shota HIGASHIHARA, Chiryu-shi (JP)

(73) Assignee: TOYOTA JIDOSHA KABUSHIKI KAISHA, Toyota-shi (JP)

(21) Appl. No.: 15/678,595

(22) Filed: Aug. 16, 2017

(30) Foreign Application Priority Data
Sep. 5, 2016 (JP) 2016-172967

(51) Int. Cl. B60N 2/56

(52) U.S. Cl. CPC B60N 2/5657; B60N 2/565

(57) ABSTRACT

A vehicle seat has: a seatback that supports a back portion of a vehicle occupant and at which back-side ventilating holes are formed in a surface seat layer, a ventilating foam layer and a back net layer; a seat cushion that supports a thigh region of the vehicle occupant from a lower side and at which cushion-side ventilating holes are formed in a surface seat layer, a ventilating foam layer and a cushion net layer; a rear hollow, an intermediate flow path portion and a lower hollow that communicate the back-side ventilating holes and the cushion-side ventilating holes; and a blower device that sends air, which has been sucked-in from one of the back-side ventilating holes and the cushion-side ventilating holes, out from another of the cushion-side ventilating holes and the back-side ventilating holes.

### CROSS-REFERENCE TO RELATED APPLICATION

This application is based on and claims priority under 35 USC 119 from Japanese Patent Application No. 2016-172967 filed on Sep. 5, 2016, the disclosure of which is incorporated by reference herein.

### BACKGROUND

### Technical Field

The present disclosure relates to a vehicle seat.

### Related Art

There has conventionally been proposed a vehicle seat in which air inlet/outlets are provided in a seating surface on which a vehicle occupant sits, and air is made to flow through the seating portion due to air being sucked-in and discharged-out. For example, Patent Document 1 (Japanese Patent Application Laid-Open (JP-A) No. 2012-111318) discloses a technique in which suction openings are provided at the seat seating portion and the backrest portion, and air that is sucked-in from the seat seating portion side is blown-out from blow-out openings provided at the front of the seat seating portion, and air that is sucked-in from the backrest portion is blown-out from blow-out openings provided at the rear of the backrest portion. Further, Patent Document 2 ((JP-A) No. 2006-35952) discloses a technique in which suction openings are provided at the front surface of a seat seating portion, and air blow-out holes are provided at the backrest portion and the seating surface of the seat seating portion, and air that is sucked-in from the suction openings is blown-out from the air blow-out holes of both the backrest portion and the seat seating portion.

By causing air to flow-through the seating portion in this way, a rise in temperature of the seating surface can be suppressed, and the comfort of the seated vehicle occupant improves.

### SUMMARY

However, in the technique of Patent Document 1, a blower must be provided at each of the seat seating portion and the seatback portion. The number of parts increases, the structure becomes complex, and the seat becomes large. Further, in Patent Document 2, although a single blower is provided at the seat, the blow-out openings of the seat seating portion and the backrest portion are disposed in parallel, and the distance from the blower to the blow-out openings of the seat seating portion and the distance from the blower to the blow-out openings of the backrest portion are different. Therefore, adjustment of the air blow-out volumes of the both is difficult.

In view of the above-described problems, an object of the present disclosure is to provide a vehicle seat that has a simple structure and in which adjustment of blown-out amounts is easy.

A vehicle seat relating to a first aspect includes: a seatback at which back-side ventilating holes are formed in a back-side supporting portion that supports a back portion of a vehicle occupant; a seat cushion at which cushion-side ventilating holes are formed in a seating surface portion that supports a thigh region of the vehicle occupant from a lower side; a communicating flow path that communicates the back-side ventilating holes and the cushion-side ventilating holes; and a blower device that is provided at the communicating flow path and that sends air, which is sucked-in from one of the back-side ventilating holes and the cushion-side ventilating holes, out from another of the cushion-side ventilating holes and the back-side ventilating holes.

In the vehicle seat relating to the first aspect, the back-side ventilating holes are formed in the back-side supporting portion of the seatback, and the cushion-side ventilating holes are formed in the seating surface portion of the seat cushion. These back-side ventilating holes and cushion-side ventilating holes are communicated by the communicating flow path. Air is sent-out by the blower device from the back-side ventilating holes toward the cushion-side ventilating holes, or from the cushion-side ventilating holes toward the back-side ventilating holes. In accordance with this structure, by a single blower device, air of the seating portion is made to flow through, and a rise in temperature of the seating surface can be suppressed, and the comfort of the seated vehicle occupant can be improved by a simple structure. Further, of the cushion-side ventilating holes and the back-side ventilating holes, air that is sucked-in from one thereof is sent-out from the other thereof. Therefore, the sucked-in amount of air and the sent-out amount of air are the same at the cushion-side ventilating holes and the back-side ventilating holes. Accordingly, adjustment of the air blow-out volume can be carried out easily as compared with a case in which the cushion-side ventilating holes and the back-side ventilating holes are disposed in parallel and air is sent-out from the both and air is sucked-in from the both.

In a vehicle seat relating to the second aspect, the communicating flow path has a back space forming member that is air impermeable and that forms a rear hollow that communicates with the back-side ventilating holes at further toward a vehicle rear side than the back-side supporting portion, and a cushion space forming member that is air impermeable and that is formed further toward a vehicle lower side than the seating surface portion and that forms a lower hollow that communicates with the cushion-side ventilating holes, and an intermediate flow path portion that communicates the rear hollow and the lower hollow.

In the vehicle seat relating to the second aspect, the communicating flow path has the back space forming member, the cushion space forming member, and the intermediate flow path portion. The back space forming member is air impermeable, and forms the rear hollow that communicates with the back-side ventilating holes. Further, the cushion space forming member is air impermeable, and forms the lower hollow that communicates with the cushion-side ventilating holes. The rear hollow and the lower hollow are communicated by the intermediate flow path portion. In this way, the communicating flow path can be formed easily by the back space forming member, the cushion space forming member and the intermediate flow path portion.

A vehicle seat relating to a third aspect has the feature that the intermediate flow path portion is a bellows shape that can extend and contract.

In accordance with the vehicle seat relating to the third aspect, even if the seatback is tilted or the angle of the seat cushion is changed, and the relative positions of the back space forming member and the cushion space forming member move, this relative movement can be absorbed at the intermediate flow path portion due to the intermediate flow path portion extending and contracting.

A vehicle seat relating to a fourth aspect has the feature that the blower device is disposed at the seat cushion side.

In accordance with the vehicle seat relating to the fourth embodiment, the seatback can be made to be thin in the vehicle longitudinal direction, as compared with a case in which the blower device is disposed at the seatback side.

A vehicle seat relating to a fifth aspect has the feature that the back-side supporting portion of the seatback and the seating surface portion of the seat cushion are structured to include net layers that are stretched and are elastic.

At the vehicle seat relating to the fifth aspect, the back-side supporting portion of the seatback, and the seating surface portion of the seat cushion, are structured to include net layers that are stretched and are elastic, and are so-called net seats that elastically support the load of the vehicle occupant by the net layers. Accordingly, the seatback and the seat cushion can be made to be so-called non-urethane structures that do not support the load of the vehicle occupant by the elasticity of a urethane layer, and the vehicle seat can be made to be thin. Further, if the back-side supporting portion and the seating surface portion are non-urethane, it is difficult for heat to accumulate thereat, and the comfort of the seated vehicle occupant can be improved. Further, because a net layer is air permeable, the back-side ventilating holes and the cushion-side ventilating holes are ensured, and there is no need to separately form the back-side ventilating holes and the cushion-side ventilating holes.

In accordance with the vehicle seat relating to the first aspect, a vehicle seat, which has a simple structure and at which adjustment of the air blow-out volume is simple, can be obtained.

In accordance with the vehicle seat relating to the second aspect, the communicating flow path can be formed by the back air portion, the cushion air portion, and the intermediate flow path portion.

In accordance with the vehicle seat relating to the third aspect, the intermediate flow path portion can be made to follow the relative movement of the seatback and the seat cushion.

In accordance with the vehicle seat relating to the fourth aspect, the vehicle seat can be made to be thin in the vehicle longitudinal direction.

In accordance with the vehicle seat relating to the fifth aspect, the vehicle seat can be made to be thin in the vehicle longitudinal direction, and the comfort of the seated vehicle occupant can be improved.

### BRIEF DESCRIPTION OF THE DRAWINGS

FIG. 1 is an overall perspective view of a vehicle seat relating to a present embodiment;

FIG. 2 is a cross-sectional view, along line 2-2 of FIG. 1, of the vehicle seat relating to the present embodiment;

FIG. 3 is a cross-sectional view along line 3-3 of FIG. 1;

FIG. 4 is an enlarged view of the IV portion of FIG. 3;

FIG. 5 is a cross-sectional view along line 5-5 of FIG. 1;

FIG. 6 is an enlarged view of the V portion of FIG. 5; and

FIG. 7 is a side sectional view of a modified example of the vehicle seat relating to the present embodiment.

### DETAILED DESCRIPTION

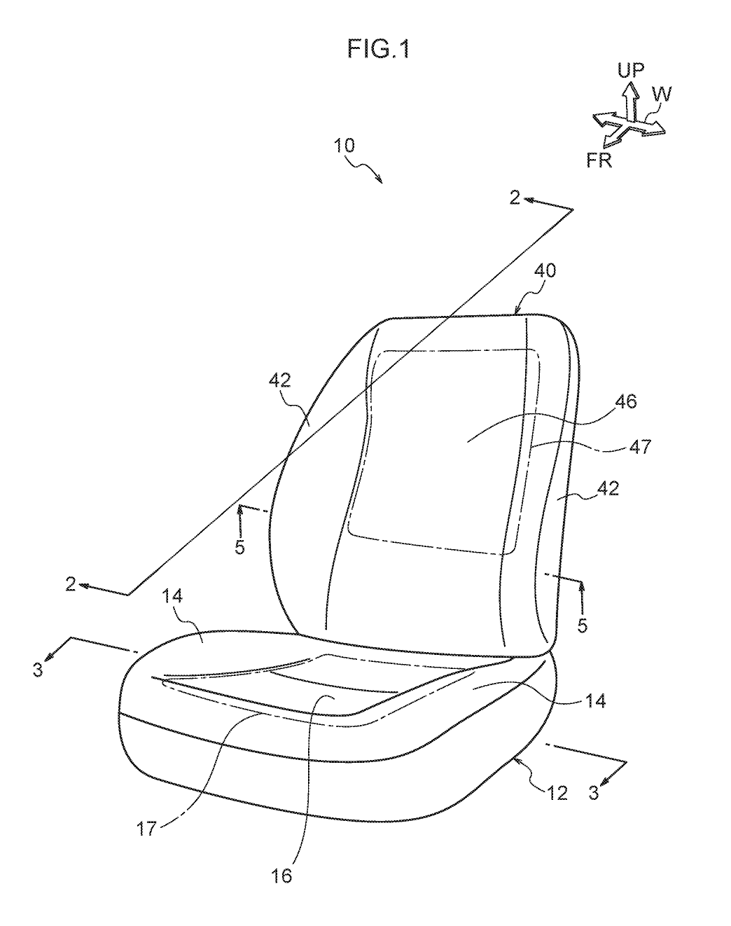

An embodiment of a vehicle seat relating to the present disclosure is described hereinafter by using FIG. 1 through FIG. 6. Note that arrow FR that is shown in these drawings indicates the vehicle longitudinal direction front side, arrow W indicates the vehicle transverse direction, and arrow UP indicates the vehicle vertical direction upper side, respectively.

As shown in FIG. 1, a vehicle seat 10 has a seat cushion 12 on which a vehicle occupant P sits, and a seatback 40 that is provided upright at the rear end portion of the seat cushion 12 and supports the upper half of the body of the vehicle occupant P. The seat cushion 12 supports the thigh region of the vehicle occupant from the lower side.

A pair of cushion side portions 14 are formed at the seat cushion 12 at the vehicle transverse direction both ends thereof. The cushion side portions 14 are convex toward the vehicle upper side. A cushion central portion 16 is formed between the pair of cushion side portions 14. The cushion central portion 16 is lower than the cushion side portions 14. The top surface of the seat cushion 12 has an external shape in which the cushion side portions 14 structure projecting portions and the cushion central portion 16 structures a bottom portion.

Further, the seat cushion 12 is inclined so as to become lower from the vehicle front side toward the vehicle rear side. A cushion ventilating region 17 is formed at the central region in the vehicle longitudinal direction of the seat cushion 12, at a position overlapping the cushion central portion 16.

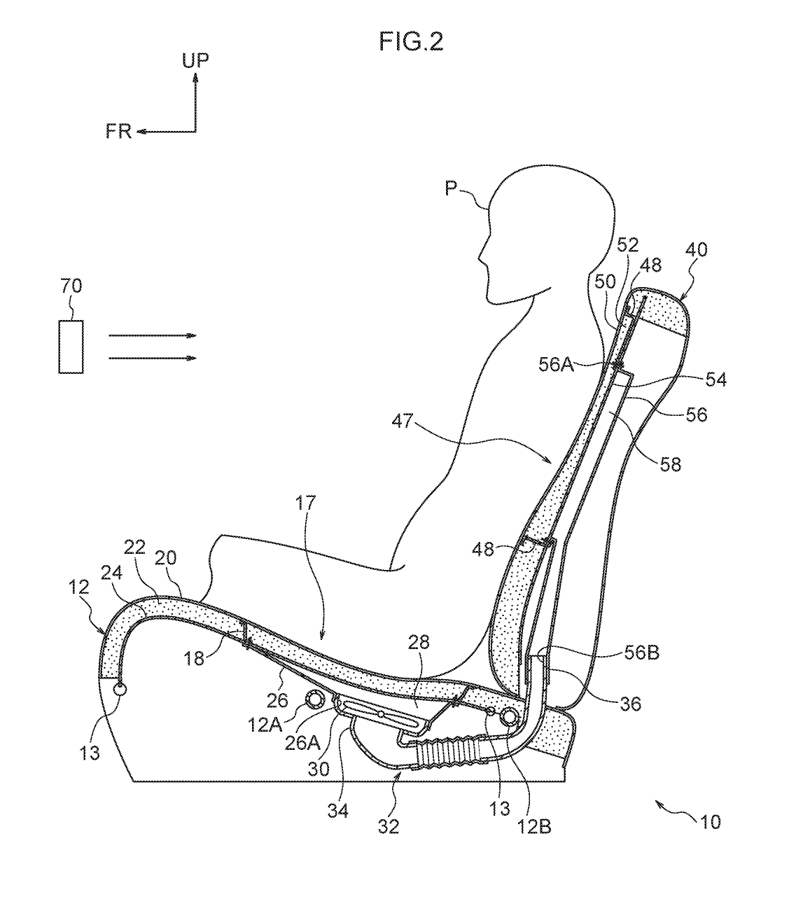

As shown in FIG. 2, a front rod 12A and a rear rod 12B are disposed at the seat cushion 12 of the vehicle seat 10. The front rod 12A extends in the vehicle transverse direction at the front side of the seat cushion 12. The rear rod 12B extends in the vehicle transverse direction at the rear side of the seat cushion 12.

The seatback 40 pivots with a reclining rod (not illustrated) being the center of pivoting thereof, and the angle of tilted of the seatback 40 can be varied.

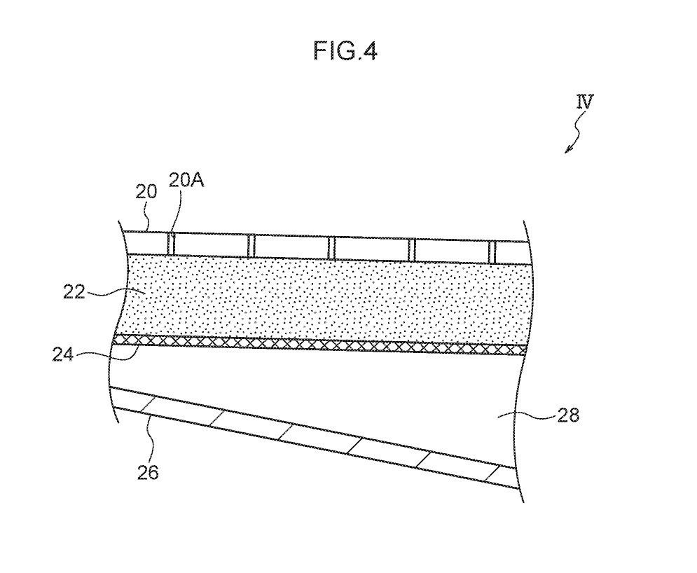

As shown in FIG. 4 as well, the seat cushion 12 has a surface seat layer 20, a ventilating foam layer 22 and a cushion net layer 24, at the seating surface side. The surface seat layer 20 structures the seating surface of the seat cushion 12, and a large number of ventilating holes 20A are provided therein. The ventilating foam layer 22 is disposed at the lower side of the surface seat layer 20, and is air permeable and cushioning. The thickness of the ventilating foam layer 22 is set to be thicker than those of the surface seat layer 20 and the cushion net layer 24.

The cushion net layer 24 is a net layer that is air permeable, and is disposed at the lower side of the ventilating foam layer 22. The both end portions in the vehicle longitudinal direction of the cushion net layer 24 (the end portions that extend in the vehicle transverse direction) are anchored on supporting wires 13 that extend in the vehicle transverse direction (see FIG. 2). Due to the supporting wires 13 being mounted respectively, via unillustrated mounting fixtures, to the frames (not illustrated) that are disposed at the front side and the rear side of the seat cushion 12, the cushion net layer 24 is stretched between these frames. The cushion net layer 24 is elastically deformable in the vehicle longitudinal direction.

The cushion-side supporting portion of the present disclosure is structured by the surface seat layer 20, the ventilating foam layer 22 and the cushion net layer 24 in the present embodiment. Note that ventilating holes are not separately formed in the ventilating foam layer 22 and the cushion net layer 24, but the materials themselves are air permeable, and the ventilating foam layer 22 and the cushion net layer 24 have ventilating holes that make it possible for air to flow therethrough. Further, in the present embodiment, the seat cushion 12 is structured by a so-called net seat at which the load of the vehicle occupant is supported by the cushion net layer 24 that is stretched.

The surface seat layer 20 can be formed by a surface skin that has high air permeability such as performance leather or the like for example. The ventilating foam layer 22 can be formed of urethane or a slab material or the like for example. The cushion net layer 24 can be formed from elastic fibers or the like for example.

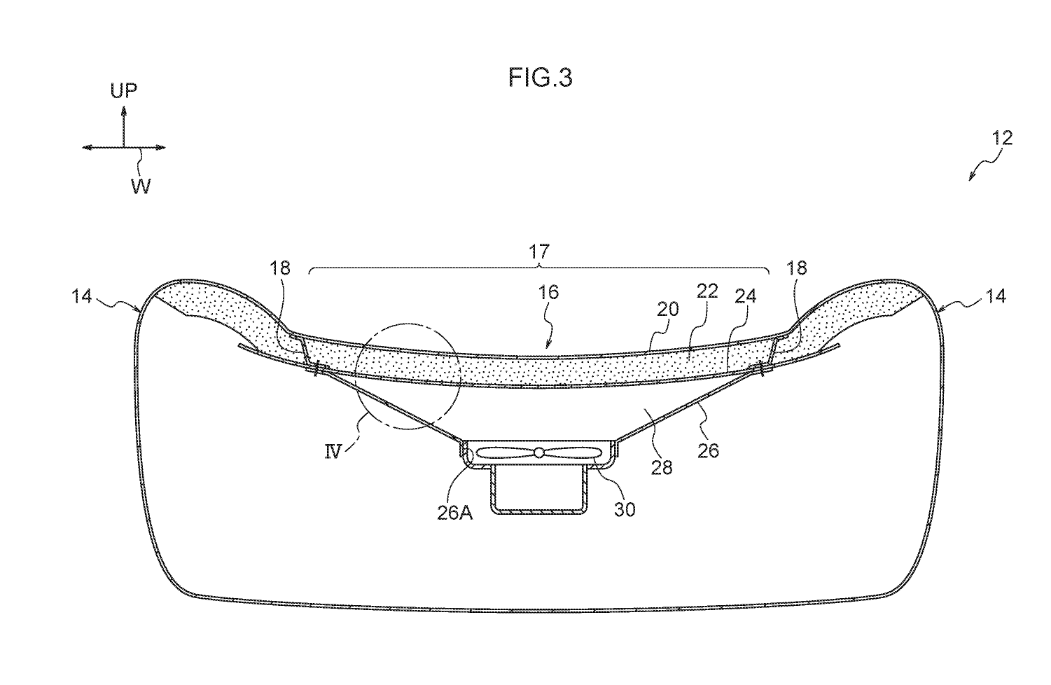

As shown in FIG. 2 and FIG. 3, partitioning members 18 are disposed at the outer edges of the portion, which corresponds to the cushion ventilating region 17, of the ventilating foam layer 22. The partitioning members 18 are made of a resin that is air impermeable, and are disposed so as to abut the surface seat layer 20 and the cushion net layer 24. The portion, which corresponds to the cushion ventilating region 17, of the ventilating foam layer 22 is sectioned-off by the partitioning members 18 from the other portions of the ventilating foam layer 22.

A cushion space forming member 26 is provided at the lower side of the cushion net layer 24 so as to cover the portion, which corresponds to the cushion ventilating region 17, of the cushion net layer 24. The outer edge of the cushion space forming member 26 is disposed along the outer edge of the portion, which corresponds to the cushion ventilating region 17, of the cushion net layer 24, and is mounted to the cushion net layer 24. A lower hollow 28 that is hollow is formed between the cushion net layer 24 and the cushion space forming member 26. The cushion space forming member 26 can be formed by a film material that is relatively flexible. This is because the lower hollow 28 is disposed at the downstream side of a blower device 30 that is described later and becomes positive pressure, and therefore, changes in the volume of the interior due to the internal pressure can be permitted. The cushion space forming member 26 can be formed of a cloth or a sheet or the like that is air impermeable.

A lower opening 26A is formed in the central portion of the cushion space forming member 26. The blower device 30 is connected to the lower opening 26A. The blower device 30 is disposed between the front rod 12A and the rear rod 12B, and the front rod 12A and the rear rod 12B are disposed at the outer side of the lower hollow 28. One end portion 34 of an intermediate flow path portion 32 that is described later is connected to the lower side of the blower device 30.

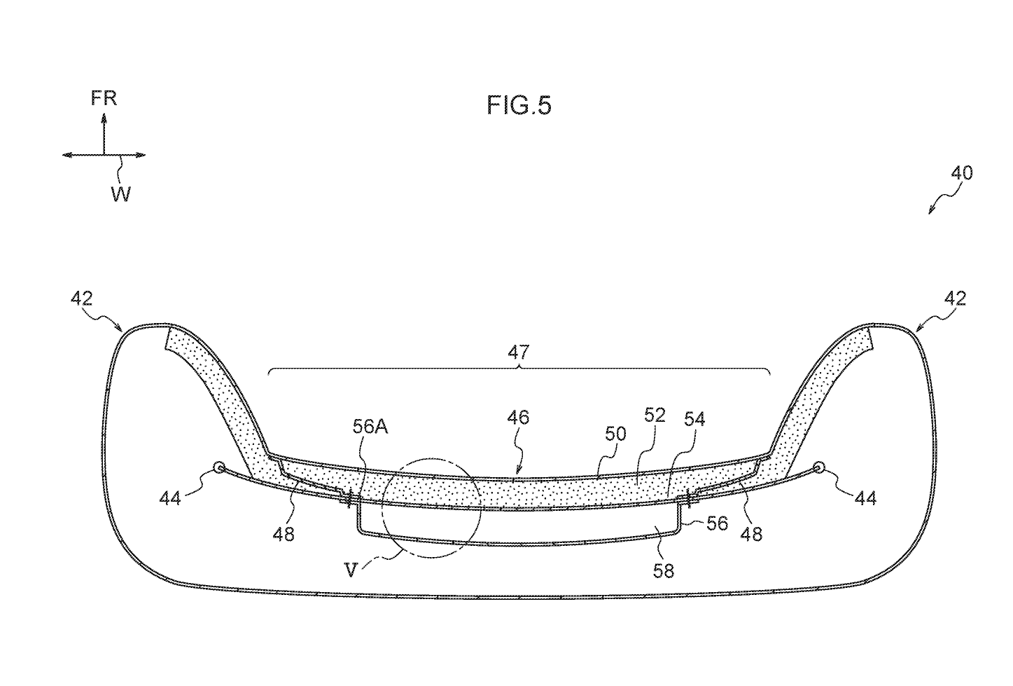

As shown in FIG. 1 and FIG. 5, a pair of side support portions 42 are formed at the both ends in the vehicle transverse direction of the seatback 40. The side support portions 42 are made to be shapes that are convex toward the vehicle front side. Supporting wires 44 that extend in the vehicle vertical direction are disposed at the side support portions 42. A back central portion 46 is formed between the pair of side support portions 42. The back central portion 46 is disposed further toward the vehicle rear side than the side support portions 42. The front surface of the seatback 40 has an outer shape in which the side support portions 42 project-out forward and the back central portion 46 is recessed rearward and structures a bottom portion.

Further, a back ventilating region 47 is formed at the central region in the vehicle vertical direction of the seatback 40, at a position overlapping the back central portion 46.

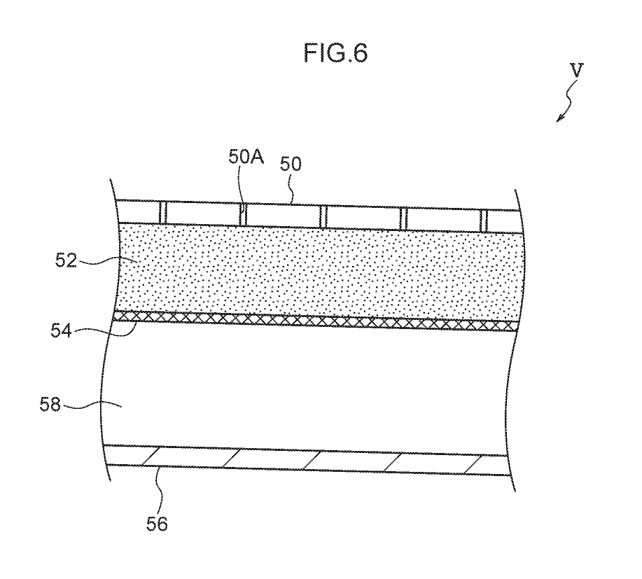

The seatback 40 has a surface seat layer 50, a ventilating foam layer 52 and a back net layer 54, at the supporting surface side that supports the upper half of the body of the vehicle occupant P. The surface seat layer 50 structures the supporting surface of the seatback 40, and, as shown in FIG. 6, a large number of ventilating holes 50A are provided therein. The ventilating foam layer 52 is disposed at the rear side of the surface seat layer 50, and is air permeable and cushioning. The thickness of the ventilating foam layer 52 is set to be thicker than those of the surface seat layer 50 and the back net layer 54.

The back net layer 54 is a net layer that is air permeable, and is disposed at the rear side of the ventilating foam layer 52. The both end portions in the vehicle transverse direction of the back net layer 54 (the end portions that extend in the vehicle vertical direction) are anchored on the supporting wires 44 (see FIG. 5). Due to the supporting wires 44 being mounted respectively, via unillustrated mounting fixtures, to a pair of frames (not illustrated) that are disposed at the vehicle transverse direction both end portions of the seatback 40, the back net layer 54 is stretched between these frames. The back net layer 54 is elastically deformable in the vehicle transverse direction.

The back-side supporting portion of the present disclosure is structured by the surface seat layer 50, the ventilating foam layer 52 and the back net layer 54 in the present embodiment. Note that ventilating holes are not separately formed in the ventilating foam layer 52 and the back net layer 54, but the materials themselves are air permeable, and the ventilating foam layer 52 and the back net layer 54 have ventilating holes that make it possible for air to flow therethrough. Further, in the present embodiment, the seatback 40 is structured by a so-called net seat at which the load of the vehicle occupant who is leaning thereagainst is supported by the back net layer 54 that is stretched.

The surface seat layer 50 can be formed by a surface skin that has high air permeability such as performance leather or the like for example. The ventilating foam layer 52 can be formed of urethane or a slab material or the like for example. The back net layer 54 can be formed from elastic fibers or the like for example.

As shown in FIG. 2 and FIG. 5, partitioning members 48 are disposed at the outer edges of the portion, which corresponds to the back ventilating region 47, of the ventilating foam layer 52. The partitioning members 48 are made of a resin that is air impermeable, and are disposed so as to abut the surface seat layer 50 and the back net layer 54. The portion, which corresponds to the back ventilating region 47, of the ventilating foam layer 52 is sectioned-off by the partitioning members 48 from the other portions of the ventilating foam layer 52.

A back space forming member 56, which extends downward and covers the portion, which corresponds to the back ventilating region 47, of the back net layer 54, is provided at the rear side of the back net layer 54. The back space forming member 56 is bag-shaped, and an upper opening 56A thereof is mounted along the outer edge of the portion, which corresponds to the back ventilating region 47, of the back net layer 54. A rear hollow 58 that is hollow is formed between the back net layer 54 and the back space forming member 56 and at the inner side of the back space forming member 56 that extends downward. It is preferable that the back space forming member 56 is formed by a member whose outer shape can be maintained relatively. This is in order to avoid contraction of the rear hollow 58 due to negative pressure because the rear hollow 58 is disposed at the upstream side of the blower device 30 that is described later and becomes negative pressure. The back space forming member 56 can be formed of a cloth or a sheet or the like that is air impermeable.

A lower opening 56B is formed at the lower end of the back space forming member 56. Another end portion 36 of the intermediate flow path portion 32 that is described later is connected to the lower opening 56B.

The intermediate flow path portion 32 is disposed via the blower device 30 between the back space forming member 56 and the cushion space forming member 26. The intermediate flow path portion 32 is, overall, formed in the shape of a tube that is hollow, and has the one end portion 34 that opens at one end side thereof and the other end portion 36 that opens at the other end side thereof. The one end portion 34 is connected to the lower side of the blower device 30, and the other end portion 36 is connected to the lower opening 56B of the back space forming member 56. A bellows portion 38, which is shaped as bellows and can extend and contract, is formed at the intermediate portion of the intermediate flow path portion 32. The communicating flow path of the present disclosure is structured by the cushion space forming member 26, the intermediate flow path portion 32 and the back space forming member 56.

The blower device 30 has a blowing function, and sends air out from the rear hollow 58 toward the lower hollow 28. As shown in FIG. 2, a blow-out port 70 for air conditioning is provided in front of the vehicle seat 10 of the vehicle. When an air conditioner (not shown) of the vehicle is operated, air is blown-out from the blow-out port 70 for air conditioning toward the seatback 40 of the vehicle seat 10, in accordance with the set temperature.

Operation of the present embodiment is described next.

When the unillustrated air conditioner and the blower device 30 are operated, air is blown-out from the blow-out port 70 for air conditioning toward the seatback 40 of the vehicle seat 10. Further, air is sucked-in from the back ventilating region 47 of the seatback 40. At the back ventilating region 47, the air passes-through the ventilating holes 50A of the surface seat layer 50, the ventilating foam layer 52 and the back net layer 54, and reaches the rear hollow 58. Moreover, the air that has been sucked-in passes from the rear hollow 58 via the intermediate flow path portion 32 and is sent-out toward the lower hollow 28, and, from the lower hollow 28, passes-through the cushion net layer 24, the ventilating foam layer 22 and the ventilating holes 20A of the surface seat layer 20, and is sent-out from the cushion ventilating region 27 of the seat cushion 12.

At the vehicle seat 10 of the present embodiment, the blower device 30 is operated, air is sucked-in from the supporting surface side of the seatback 40, and this air that has been sucked-in is sent-out from the seating surface side of the seat cushion 12. Accordingly, air of the seating portion is made to flow-through, and a rise in the temperature of the seating surface can be suppressed, and the comfort of the seated vehicle occupant can be improved.

Further, because air of the seating portion can be made to flow-through by the one blower device 30, the vehicle seat can be made to be a simple structure.

Moreover, the air, which has been sucked-in from the back ventilating region 47 of the seatback 40, is sent-out from the cushion ventilating region 27 of the seat cushion 12. Therefore, the amount of air that is sucked-in and the amount of air that is sent-out are the same. Accordingly, adjustment of the air blow-out volume can be carried out easily as compared with a case in which ventilating holes at the seat cushion side and the seatback side are disposed in parallel and air is sent-out from the both and air is sucked-in from the both.

Further, in the present embodiment, the bellows portion 38, which is bellows-shaped and can extend and contract, is formed at the intermediate portion of the intermediate flow path portion 32. Accordingly, even if the seatback 40 is tilted or the angle of the seat cushion 12 is changed, and the relative positions of the back space forming member 56 and the cushion space forming member 26 move, this relative movement can be absorbed due to the bellows portion 38 of the intermediate flow path portion 32 extending and contracting.

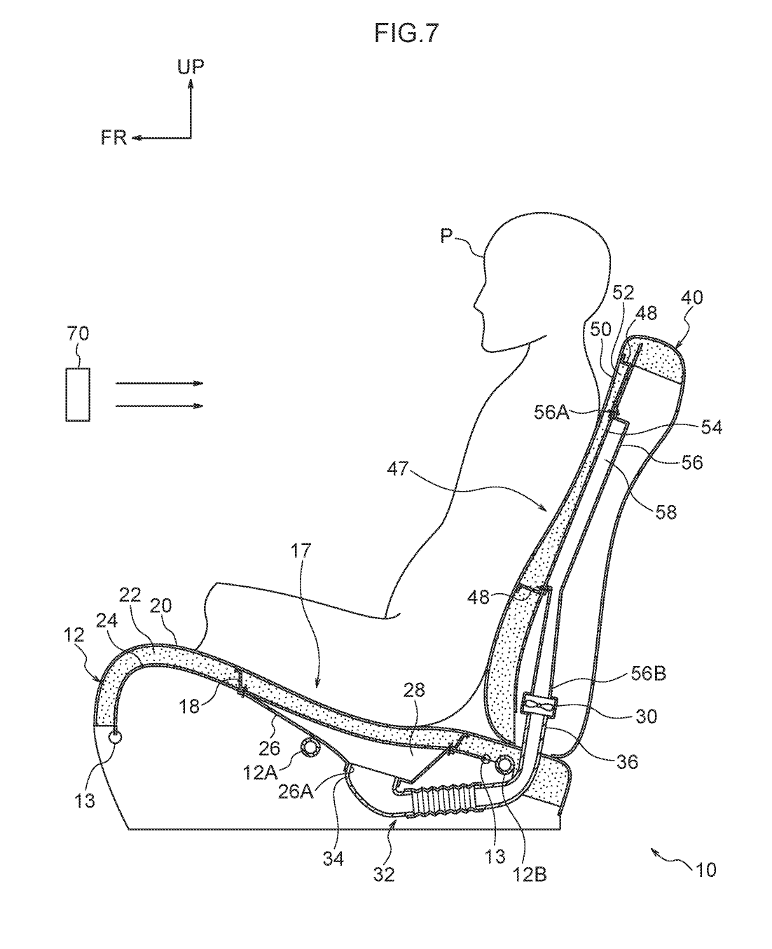

Note that, in the present embodiment, the blower device 30 is set at the lower portion of the seat cushion 12, but, as shown in FIG. 7, the blower device 30 may be set at the seatback 40 side and connected to the other end portion 36 of the intermediate flow path portion 32. By setting the blower device 30 at the lower portion of the seat cushion 12 as in the present embodiment, the thickness of the seatback 40 in the vehicle longitudinal direction can be made to be thin, and the seatback 40 can be made to be thin.

Further, in the present embodiment, air is sent-out from the seatback 40 side toward the seat cushion 12. However, the direction in which air is sent-out by the blower device 30 may be from the seat cushion 12 side toward the seatback 40 side. By sending air out from the seatback 40 side toward the seat cushion 12 as in the present embodiment, the air that is blown-out from the blow-out port 70 for air conditioning toward the seatback 40 can be smoothly sucked-in from the back ventilating region 47 of the seatback 40.

Note that, due to the cooling air, which is blown-out from the blow-out port 70 for air conditioning toward the seatback 40, being taken into the seatback 40, the cooling air can effectively be made to flow at the periphery of the vehicle occupant. Further, by sending the cooling air out from the seating surface of the seat cushion 12, the cooling air can be directly blown-out onto the thigh region of the vehicle occupant.

Moreover, although the seat cushion 12 and the seatback 40 are structured by net seats in the present embodiment, they do not necessarily have to be structured by net seats and can also be structured by using urethane that has low air permeability as cushion materials therefor. In this case, back-side ventilating holes and cushion-side ventilating holes are separately formed in these urethane cushion materials.

Although an embodiment of the present disclosure has been described above, the present disclosure is not limited to the above, and, of course, can be implemented by being modified in various ways other than the above within a scope that does not depart from the gist thereof.

What is claimed is:

1. A vehicle seat comprising:
a seatback at which back-side ventilating holes are formed in a back-side supporting portion that supports a back portion of a vehicle occupant;
a seat cushion at which cushion-side ventilating holes are formed in a seating surface portion that supports a thigh region of the vehicle occupant from a lower side;
a communicating flow path that communicates the back-side ventilating holes and the cushion-side ventilating holes; and
a blower device that is provided at the communicating flow path and that sends air, which is sucked-in from one of the back-side ventilating holes and the cushion-side ventilating holes, out from another of the cushion-side ventilating holes and the back-side ventilating holes.

2. The vehicle seat of claim 1, wherein the communicating flow path has a back space forming member that is air impermeable and that forms a rear hollow that communicates with the back-side ventilating holes at further toward a vehicle rear side than the back-side supporting portion, and a cushion space forming member that is air impermeable and that is formed further toward a vehicle lower side than the seating surface portion and that forms a lower hollow that communicates with the cushion-side ventilating holes, and an intermediate flow path portion that communicates the rear hollow and the lower hollow.

3. The vehicle seat of claim 2, wherein the intermediate flow path portion is a bellows shape that can extend and contract.

4. The vehicle seat of claim 1, wherein the blower device is disposed at the seat cushion side.

5. The vehicle seat of claim 2, wherein the blower device is disposed at the seat cushion side.

6. The vehicle seat of claim 3, wherein the blower device is disposed at the seat cushion side.

7. The vehicle seat of claim 1, wherein the blower device is disposed at the seatback side.

8. The vehicle seat of claim 2, wherein the blower device is disposed at the seatback side.

9. The vehicle seat of claim 3, wherein the blower device is disposed at the seatback side.

10. The vehicle seat of claim 1, wherein the back-side supporting portion of the seatback and the seating surface portion of the seat cushion are structured to include net layers that are stretched and are elastic.

11. The vehicle seat of claim 2, wherein the back-side supporting portion of the seatback and the seating surface portion of the seat cushion are structured to include net layers that are stretched and are elastic.

12. The vehicle seat of claim 3, wherein the back-side supporting portion of the seatback and the seating surface portion of the seat cushion are structured to include net layers that are stretched and are elastic.
